(19) United States
(12) Patent Application Publication
(10) Pub. No.: US 2011/0036224 A1
(43) Pub. Date: Feb. 17, 2011

(54) Cutting angle adjustment device for a circular saw machine

(75) Inventor: Chien-Hsing Liu, Taichung County (TW)

Correspondence Address: OHLANDT, GREELEY, RUGGIERO & PERLE, LLP, ONE LANDMARK SQUARE, 10TH FLOOR, STAMFORD, CT, 06901, US

(73) Assignee: P & F BROTHER INDUSTRIAL CORP.

(21) Appl. No.: 12/583,026

(22) Filed: Aug. 13, 2009

(51) Int. Cl. B26D 7/26

(52) U.S. Cl. 83/471.3

(57) ABSTRACT

A cutting angle adjustment device for a circular saw machine includes: a base frame; a worktable rotatably mounted on the base frame; a fine-adjustment unit disposed on a frontward area of the base frame and having an arcuate rack segment; and an adjustment actuating unit having a pinion engageable with the rack segment, an actuating shaft rotatably and movably mounted on an arm of the worktable and coupled with the pinion such that, when the actuating shaft is moved from a normal position to a pressed position, the pinion-is brought into engagement with the rack segment to enable angular movement of the arm relative to the base frame for fine-adjustment of the cutting angle of the worktable, and a biasing member disposed to bias the actuating shaft to the normal position.

### BACKGROUND OF THE INVENTION

1. Field of the Invention

This invention relates to a circular saw machine, more particularly to a cutting angle adjustment device for a circular saw machine which is operable to turn a worktable relative to a base frame for fine-adjustment of cutting angles.

2. Description of the Related Art

Referring to FIG. 1, a conventional miter saw 10 generally includes a base frame 11, a turntable 12 rotatably mounted on the base frame 11, a tightening member 13 disposed on a lower portion of an arm of the turntable 12, and an adjusting member 14. An arcuate rack 111 is formed on an outer periphery of the base frame 11. The tightening member 13 includes a threaded bolt 131 threadedly engaged with the arm, and a tightening handle 132 disposed on a front end of the threaded bolt 131 and operable to rotate the threaded bolt 131 to cause a rear end of the threaded bolt 131 to retainingly abut against the base frame 11 so as to retain the turntable 12 at a desired angular position. The adjusting member 14 is movably sleeved on the threaded bolt 131, and has a pinion 142 and a rotary knob 141 mounted respectively on rear and front ends thereof. A spring 15 is disposed between the arm and the adjusting member 14 to bias the adjusting member 14 forwardly. When it is desired to fine-tune the angular position of the turntable 12, the adjusting member 14 is first pressed rearwardly to enable the pinion 142 to mesh with the rack 111, and is then turned to result in movement of the turntable 12 by means of gearing between the rack 111 and the pinion 142.

Although the turntable 12 can be adjusted to a desired angular position, the conventional miter saw 10 suffers from the following drawbacks:

1. Since the rack 111 is integrally formed with the base frame 11, the teeth of the rack 111 are liable to wear after long-term use, which will adversely affect the precision of angle adjustment. The rack 111, once worn, requires repairs. Even the entire base frame 11 requires replacement.

2. Since the base frame 11 is made from aluminum material that is less rigid than the material of the threaded bolt 131, the base frame 11 is subject to wear when the threaded bolt 131 retainingly abuts against the base frame 11. As a result, the retainment of the turntable 12 on the base frame 11 is adversely affected.

### SUMMARY OF THE INVENTION

The object of the present invention is to provide a cutting angle adjustment device for a circular saw machine, in which a worktable is turnable relative to a base frame for fine-adjustment of cutting angles, which is configured to have prolonged service life, and which ensures secure coupling between the base frame and the worktable.

According to this invention, the cutting angle adjustment device for a circular saw machine includes a base frame which has a central area with a circumferential borderline surrounding a central axis, and a frontward area extending radially and forwardly of the circumferential borderline, and a worktable which is disposed on the central area and rotatable relative to the circumferential borderline about the central axis, and which includes a table body and an arm extending radially and forwardly of the frontward area. A fine-adjustment unit is disposed on the frontward area, and extends radially and forwardly to terminate at a forefront arcuate edge. The fine-adjustment unit has inner proximate and distal arcuate surfaces which extend angularly about the central axis and which are radially spaced apart from each other to define an arcuate slot therebetween, and an arcuate rack segment formed on the inner proximate arcuate surface. An adjustment actuating unit includes a pinion engageable with the arcuate rack segment, and an actuating shaft which is rotatably mounted on the arm about a revolving axis, and which is movable along the revolving axis between a normal position, where the actuating shaft is remote from the arcuate rack segment, and a pressed position, where the actuating shaft is closer to the arcuate rack segment. The actuating shaft includes an actuating end which is coupled to the pinion so as to be movable and rotatable with the pinion such that, in the normal position, the teeth of the pinion are radially set apart from the arcuate rack segment in the arcuate slot, and, in the pressed position, a lowest one of the teeth of the pinion is brought into engagement with the arcuate rack segment to enable angular movement of the arm relative to the angle adjustment unit when the actuating shaft is rotated, and an externally operable end which is opposite to the actuating end in the revolving axis and which is disposed forwardly and outwardly of the arm. The adjustment actuating unit further includes a biasing member disposed to bias the actuating shaft to move towards the normal position.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a fragmentary sectional view of a conventional miter saw;

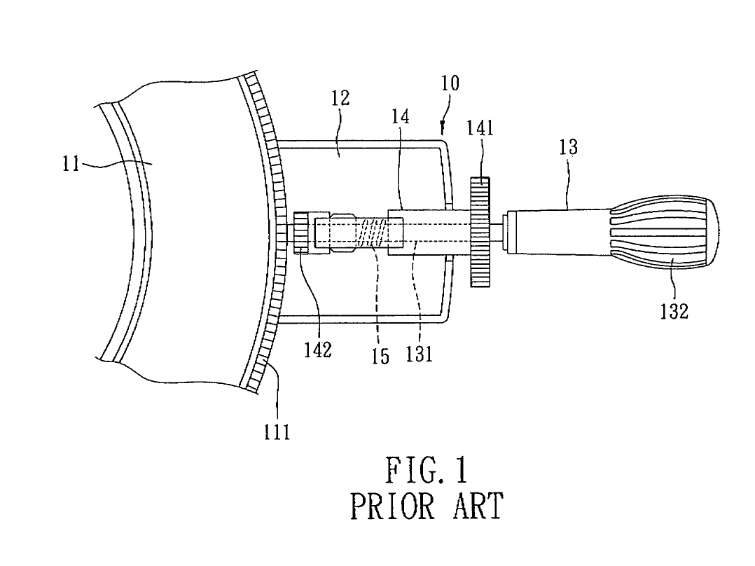

FIG. 2 is an exploded perspective view of the first preferred embodiment of a cutting angle adjustment device for a circular saw machine according to this invention;

FIG. 3 is a fragmentary sectional view of the first preferred embodiment when a tightening unit is in a releasing position;

FIG. 4 is an exploded perspective view of the first preferred embodiment;

FIG. 5 is a top view of the first preferred embodiment illustrating an actuating shaft in a normal position;

FIG. 6 is a sectional view taken along lines VI-VI of FIG. 5;

FIG. 7 is a fragmentary sectional view of the first preferred embodiment when the tightening unit is in a tightening position;

FIG. 8 is a top view of the first preferred embodiment illustrating the actuating shaft in a pressed position;

FIG. 9 is a sectional view taken along lines IX-IX of FIG. 8;

FIG. 10 is a fragmentary sectional view of the second preferred embodiment according to this invention;

FIG. 11 is a perspective view of a fixing unit of the second preferred embodiment;

FIG. 12 is a fragmentary sectional view of the third preferred embodiment of a cutting angle adjustment device for a circular saw machine according to this invention: and

FIG. 13 is a perspective view of a fixing unit of the third preferred embodiment.

### DETAILED DESCRIPTION OF THE PREFERRED EMBODIMENTS

Before the present invention is described in greater detail, it should be noted that same reference numerals have been used to denote like elements throughout the specification.

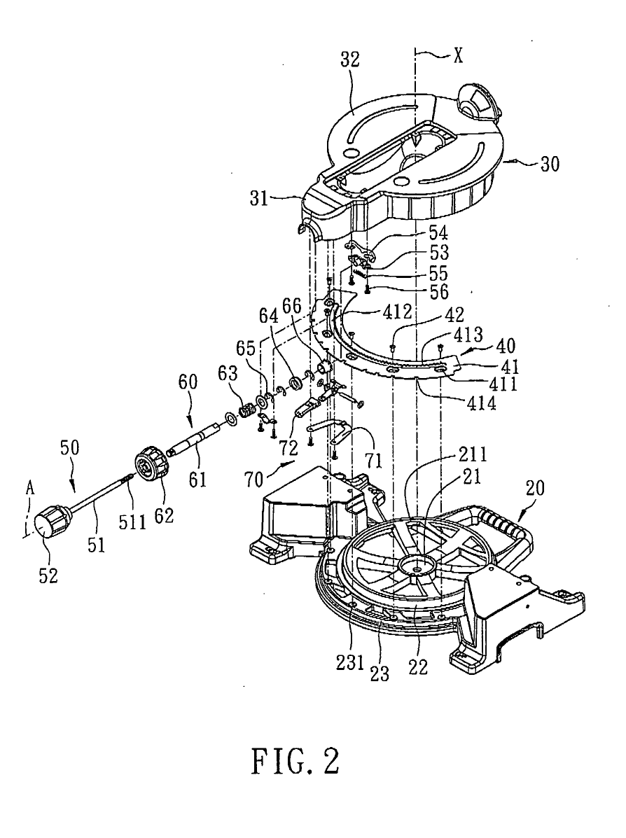

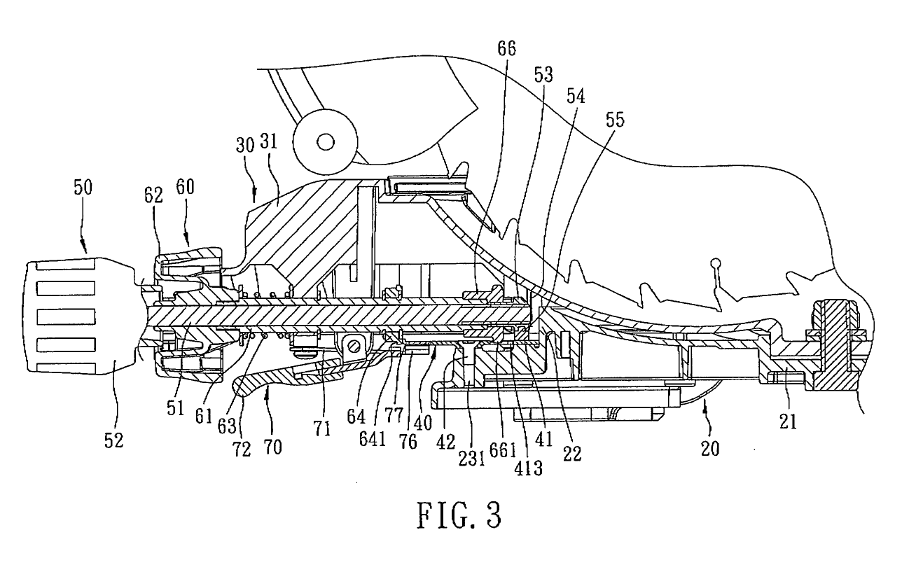

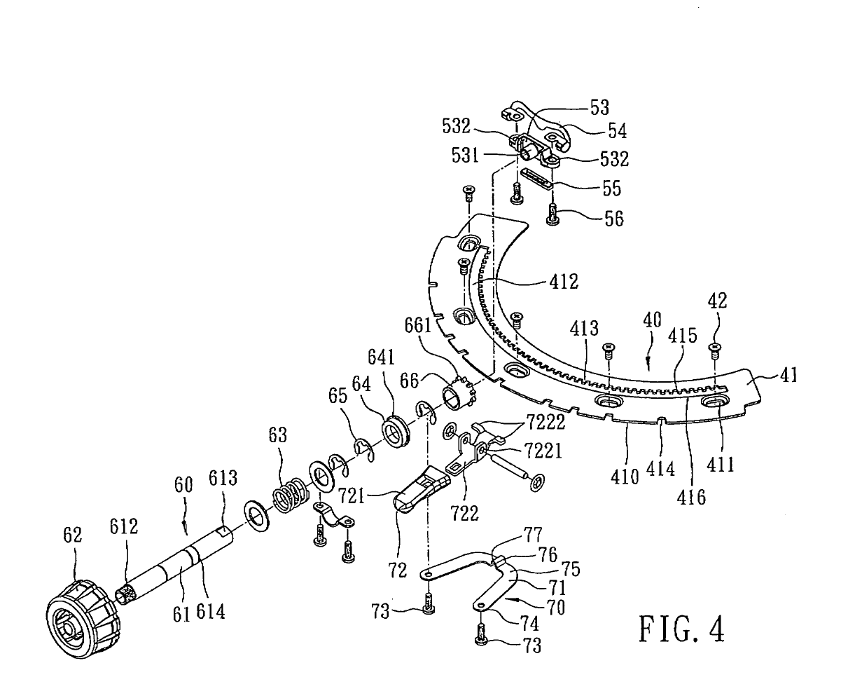

Referring to FIGS. 2 to 4, the first preferred embodiment of a cutting angle adjustment device for a circular saw machine according to the present invention is shown to comprise a base frame 20, a worktable 30, a fine-adjustment unit 40, a tightening unit 50, an adjustment actuating unit 60, and a fixing unit 70.

The base frame 20 includes a major wall which defines a central axis (X) normal to the major wall, and which has a central area 21 that has a circumferential borderline 211 surrounding the central axis (X), and a frontward area 23 that extends radially and forwardly of the circumferential borderline 211. An arcuate abutment wall 22 is disposed uprightly on the frontward area 23 and surrounds the central axis (X).

The worktable 30 is disposed on the central area 21 and is rotatable relative to the circumferential borderline 211 about the central axis (X). The worktable 30 includes a table body 32 for supporting a workpiece (not shown) to be cut, and an arm 31 which extends radially from an outer periphery of the table body 32 and forwardly of the frontward area 23. A circular saw unit (not shown) is cantileveredly mounted over and is pivotably movable toward and away from the worktable 30 such that turning of the worktable 30 relative to the base frame 20 results in changing of a cutting angle of the circular saw unit to the workpiece on the worktable 30.

The fine-adjustment unit 40 includes an arcuate flat plate 41 which has a plurality of elongated bores 411 angularly formed therein. A plurality of screws 42 extend respectively through the elongated bores 411 and are engaged threadedly and respectively with a plurality of screw holes 231 provided in the frontward area 23 so as to secure the arcuate flat plate 41 on the frontward area 23. The arcuate flat plate 41 extends radially and forwardly to terminate at a forefront arcuate edge 410 which has a plurality of scaling notches 414 angularly displaced from one another about the central axis (X) at predetermined angularly positions. The arcuate flat plate 41 further has inner proximate and distal arcuate surfaces 415, 416 which extend angularly about the central axis (X) and which are spaced apart from each other radially to define an arcuate slot 412 therebetween, and an arcuate rack segment 413 formed on the inner proximate arcuate surface 415.

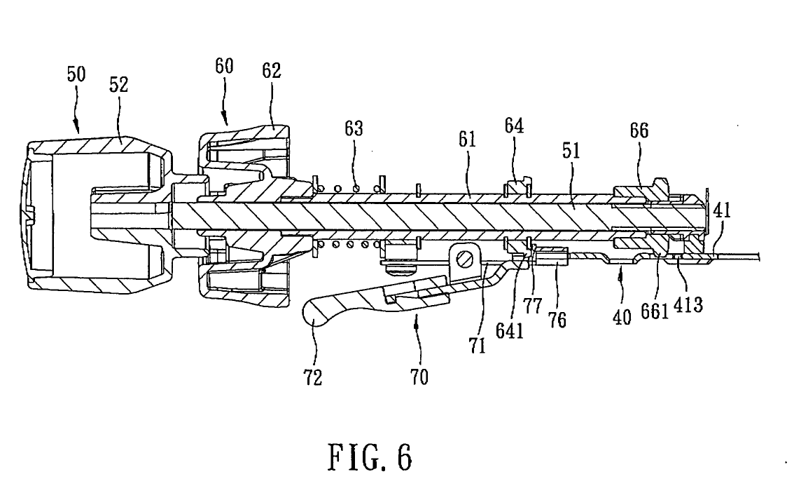

Referring to FIGS. 2 to 6, the tightening unit 50 has a tightening bolt 51 which is rotatably mounted on the arm 31 about a revolving axis (A) radial to the central axis (X), and which has a threaded segment 511 adjacent to the arcuate abutment wall 22, a rotary knob 52 connected to a front end of the tightening bolt 51 to be operable manually, an abutment member 53 which is threadedly engaged with the threaded segment 511, and a spring member 54 which is interposed between the abutment member 53 and the arcuate abutment wall 22, and a pad member 55 which is disposed between the abutment member 53 and the arcuate flat plate 41 adjacent to the arcuate abutment wall 22. The abutment member 53 has a central threaded tube 531 threadedly engaged with the threaded segment 511, and two lugs 532 at two opposite sides of the central threaded tube 531. The spring member 54 is a leaf spring which has two ends secured respectively on the lugs 532 by means of screws 56 to permit a spring body of the spring member 54 to suspend from the abutment member 53. Thus, rotation of the tightening bolt 51 about the revolving axis (A) results in movement of the abutment member 53 relative to the arcuate abutment wall 22. In addition, the abutment member 53 is moved to abut against the arcuate abutment wall 22 against a biasing action of the spring member 54 so as to guard against angular movement of the arm 31 relative to the base frame 20. Moreover, by virtue of the arrangement of the pad member 55, the threaded engagement between the tightening bolt 51 and the abutment member 53 is stabilized, and the arcuate flat plate 41 can be pressed to prevent undesirable bending of the arcuate flat plate 41.

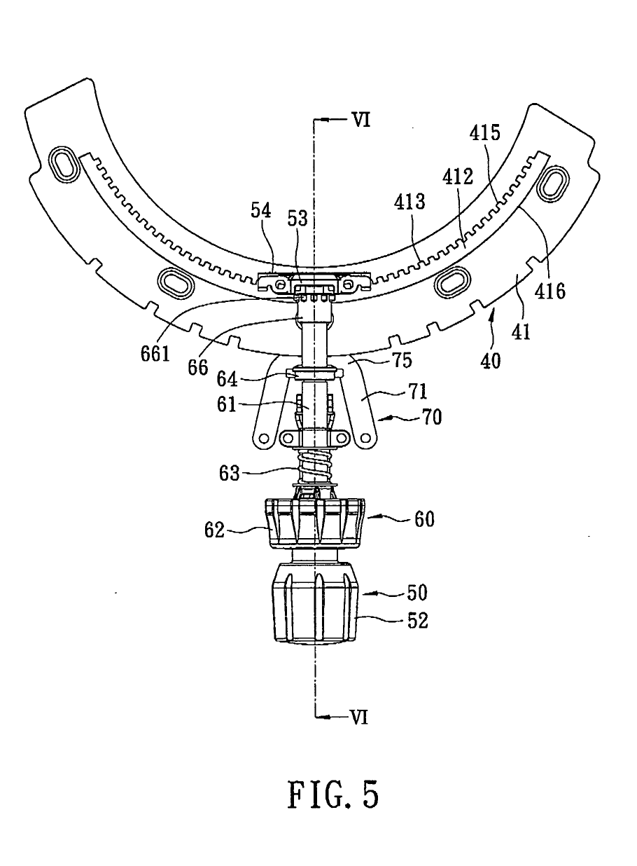

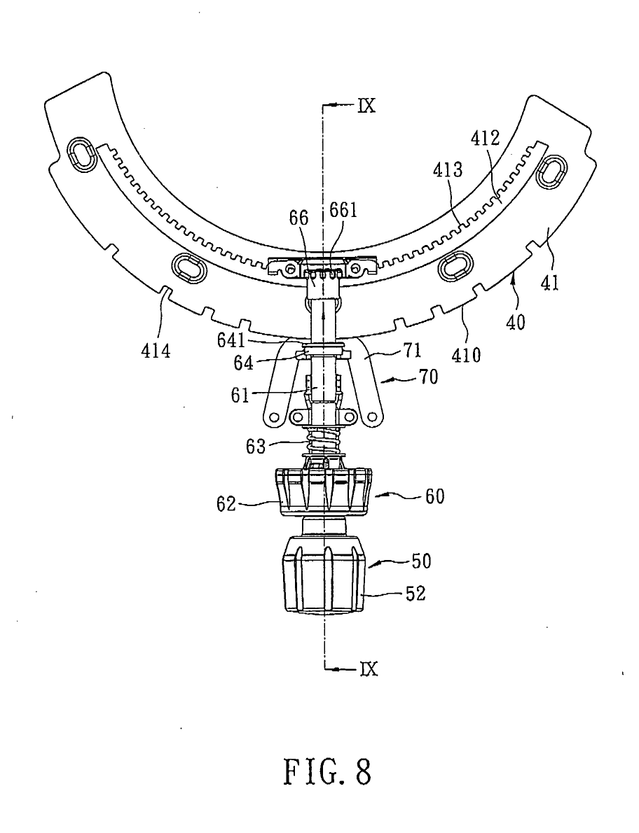

The adjustment actuating unit 60 includes a tubular actuating shaft 61 which is sleeved on the tightening bolt 51, which is rotatably mounted on the arm 31 about the revolving axis (A), and which is movable along the revolving axis (A) between a normal position, where the actuating shaft 61 is remote from the arcuate rack segment 413, and a pressed position, where the actuating shaft 61 is closer to the arcuate rack segment 413, a rotary knob 62 which is connected to an externally operable end 612 of the actuating shaft 61 and which is disposed forwardly and outwardly of the arm 31, a biasing member 63 sleeved on the actuating shaft 61, and a pinion 66 which is coupled to an actuating end 613 of the actuating shaft 61 opposite to the externally operable end 612 so as to be movable and rotatable with the actuating end 613 along and about the revolving axis (A). The actuating shaft 61 has an intermediate segment which is interposed between the actuating end 613 and the externally operable end 612, and which has two annular grooves 614. The biasing member 63 has opposite ends abutting respectively against the arm 31 and the knob 62 so as to bias the actuating shaft 61 forwardly to the normal position. A sleeve body 64 is mounted on and is rotated with the intermediate segment of the actuating shaft 61 by means of two substantially E-shaped loops 65 that are engaged in the annular grooves 614. A flange 641 extends radially and outwardly from the sleeve body 64 and has a guiding slope. The pinion 66 has a plurality of teeth 661 which are angularly displaced from one another about the revolving axis (A) such that, when the actuating shaft 61 is in the normal position, as shown in FIG. 5, the teeth 661 of the pinion 66 are radially set apart from the arcuate rack segment 413 in the arcuate slot 412, and when the actuating shaft 61 is in the pressed position, as shown in FIG. 8, a lowest one of the teeth 661 of the pinion 66 is brought into engagement with the arcuate rack segment 413.

The fixing unit 70 has two anchoring ends 74 secured respectively by means of two screws 73 to the arm 31, a leaf spring segment 71 which extends radially to terminate at an urging end 75 that is disposed beneath the forefront arcuate edge 410, and a wedge-shaped retaining member 76 which is disposed on the urging end 75 and which is to be snapped into engagement with a selected one of the scaling notches 414 so as to permit the worktable 30 to be held at a certain angular position. A catch 77 is disposed on the retaining member 76, and cooperates with the sleeve body 64 and the flange 641 to serve as a hook-up mechanism. The fixing unit 70 further has a lever 72 which includes a lever body 721 and a pivot body 722. The lever body 721 is connected to a front end of the pivot body 722 to serve as a power end of the lever 72. The pivot body 722 has two wing portions 7222 which are disposed opposite to the lever body 721, which serve as a weight end of the lever 72, and which are disposed to abut against the leaf spring segment 71, and a fulcrum 7221 which is pivotally mounted on the arm 31. Thus, when an upward force is applied manually to the lever body 721, the wing portions 7222 and the leaf spring segment 71 will move downwardly so as to disengage the retaining member 76 from the selected one of the scaling notches 414.

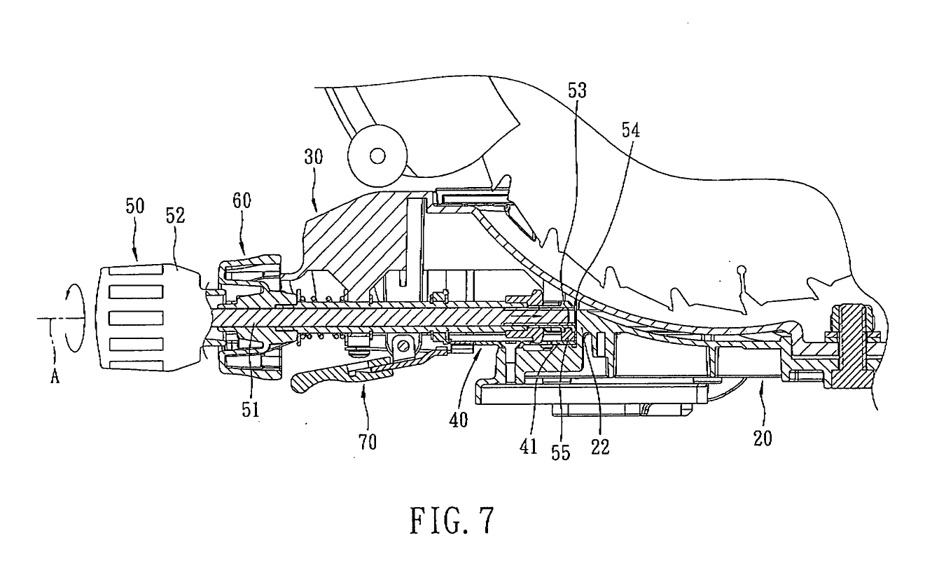

Referring to FIG. 7, when it is desired to retain the worktable 30 at a predetermined angular position, the rotary knob 52 is turned about the revolving axis (A) to move the abutment member 53 along the revolving axis (A) such that the abutment member 53 abuts against the arcuate abutment wall 22 against the biasing action of the spring member 54, thereby firmly guarding against angular movement of the worktable 30 relative to the base frame 20.

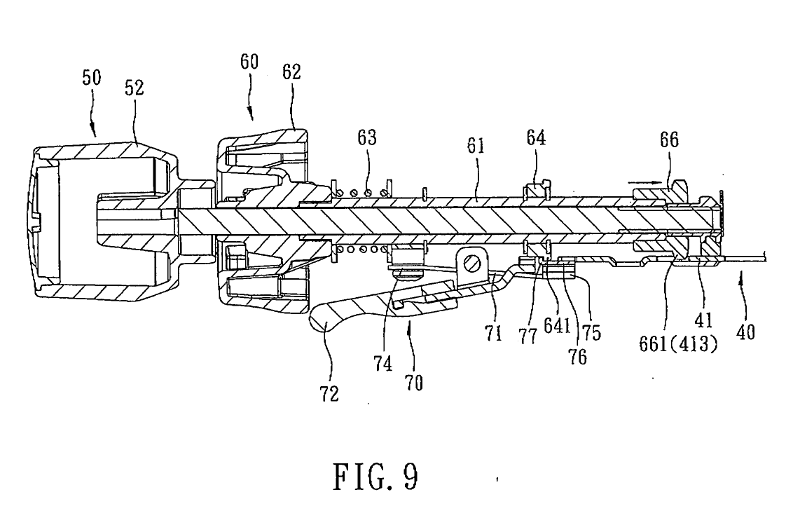

Referring to FIGS. 8 and 9, when it is desired to perform fine-adjustment of a cutting angle, and when the retaining member 76 is disengaged from the scaling notches 414 and is biased upwardly to be kept in slidable contact with the forefront arcuate edge 410, the rotary knob 62 is pressed rearwardly to bring the actuating shaft 61 to the pressed position, the flange 641 is forced over the catch 77 and is rotatably retained with the catch 77 against the biasing force of the biasing member 63 so as to guard against disengagement of the pinion 66 from the arcuate rack segment 413, thereby maintaining the actuating shaft 61 in the pressed position. Subsequently, the rotary knob 62 is rotated to permit the pinion 66 to move along the arcuate rack segment 413 so as to enable angular movement of the arm 31 relative to the angle adjustment unit 40 for fine-adjustment of the cutting angle of the worktable 30. After the fine-adjustment operation, the lever body 721 is pulled upwardly such that the leaf spring segment 71 is pressed downwardly to release the flange 641 from the catch 77, thereby permitting the actuating shaft 61 to be biased to the normal position by the biasing action of the biasing member 63 and permitting the pinion 66 to disengage from the arcuate rack segment 413.

As illustrated, since the arcuate flat plate 41 may be detachably secured on the base frame 20, and has the arcuate rack segment 413 meshing with the pinion 66 for fine-adjustment of the cutting angle, the adjustment actuating unit 40 may be removed and replaced once the arcuate rack segment 413 is worn or damaged without the need to replace the whole base frame 20. This is advantageous in terms of cost-effectiveness and convenient assembly. Moreover, by means of the spring member 54 and the pad member 55, the abutment member 53 can firmly abut against the arcuate abutment wall 23 and protect the arcuate abutment wall 23 from wear so as to prolong the service life of the tightening unit 50.

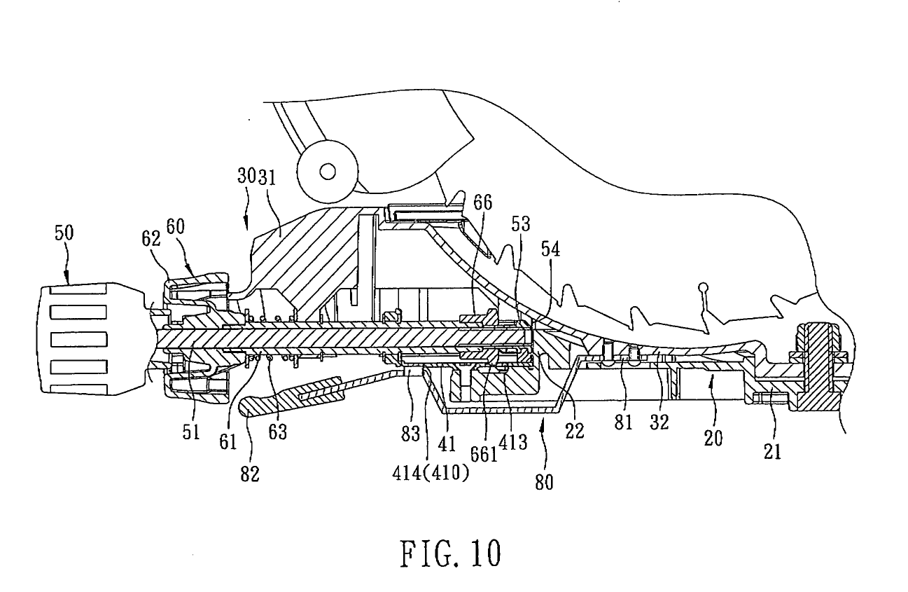

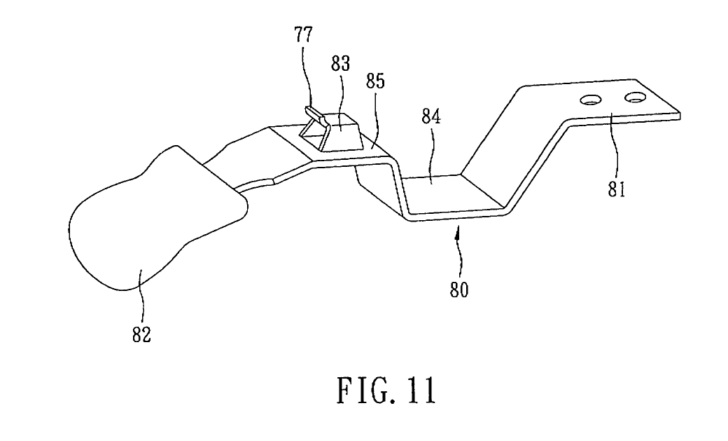

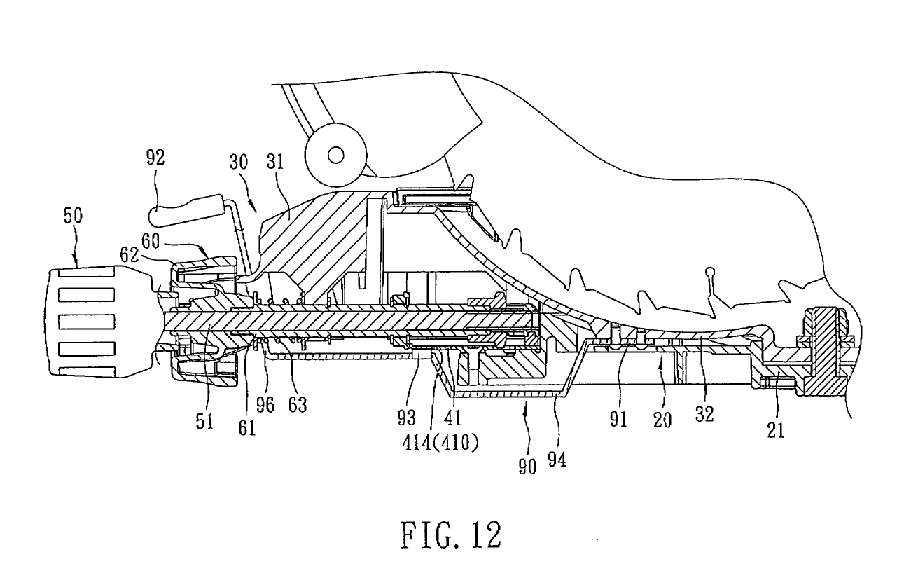

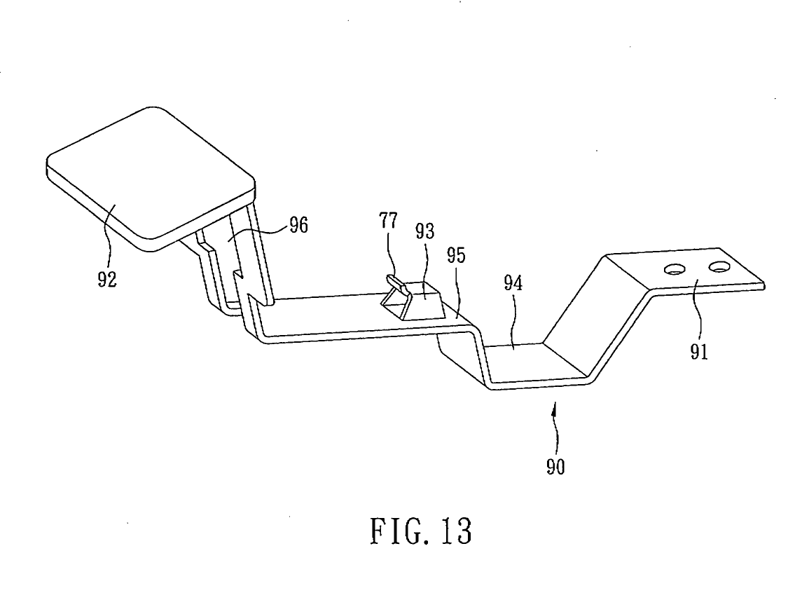

Referring to FIGS. 10 to 13, the second and third preferred embodiments of the cutting angle adjustment device according to this invention are similar to the first embodiment in construction, except that, in the second and third embodiments, the fixing unit 80, 90 is in the form of an elongated leaf spring, and includes an anchoring end 81, 91 secured to the table body 32 and opposite to the arm 31 radially, a leaf spring segment 84, 94 which extends radially to terminate at an urging end 85, 95 that is disposed beneath the forefront arcuate edge 410, and that is biased upwardly so as to be kept in slidable contact with the forefront arcuate edge 410 during angular movement of the arm 31, a retaining member 83, 93 which is disposed on the urging end 85, 95 and which is to be snapped into engagement with a selected one of the scaling notches 414, and a tongue segment 82, 92 extending forwardly from the urging end 85, 95 to facilitate manual operation of the tongue segment 82, 92 to disengage the retaining member 83, 93 from the selected one of the scaling notches 414. In the second embodiment, the tongue segment 82 is disposed beneath the actuating shaft 61 adjacent to the rotary knob 62. In the third embodiment, the tongue segment 92 has an elongated slot 96 for extension of the rotary knob 62 therethrough. The tongue segment 92 extends upwardly to be disposed above the rotary knob 62.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

I claim:

1. A cutting angle adjustment device for a circular saw machine, comprising:
a base frame including a major wall which defines a S central axis normal to said major wall, and which has a central area that has a circumferential borderline surrounding the central axis, and a frontward area that extends radially and forwardly of said circumferential borderline;
a worktable which is disposed on said central area and which is rotatable relative to said circumferential borderline about the central axis, said worktable including a table body which has an outer periphery, and an arm which extends radially from said outer periphery and forwardly of said frontward area;
a fine-adjustment unit which is disposed on said frontward area, and which extends radially and forwardly to terminate at a forefront arcuate edge, said fine-adjustment unit having inner proximate and distal arcuate surfaces which extend angularly about the central axis and which are spaced apart from each other radially to define an arcuate slot therebetween, and an arcuate rack segment formed on said inner proximate arcuate surface; and
an adjustment actuating unit including
a pinion which has a plurality of teeth that are angularly displaced from one another about a revolving axis radial to the central axis, and that are engageable with said arcuate rack segment,
an actuating shaft which is rotatably mounted on said arm about the revolving axis, and which is movable along the revolving axis between a normal position, where said actuating shaft is remote from said arcuate rack segment, and a pressed position, where said actuating shaft is closer to said arcuate rack segment, said actuating shaft including an actuating end which is coupled to said pinion so as to be movable and rotatable with said pinion such that, in the normal position, said teeth of said pinion are radially set apart from said arcuate rack segment in said arcuate slot, and, in the pressed position, a lowest one of said teeth of said pinion is brought into engagement with said arcuate rack segment to enable angular movement of said arm relative to said angle adjustment unit when said actuating shaft is rotated, and an externally operable end which is opposite to said actuating end in the revolving axis and which is disposed forwardly and outwardly of said arm, and
a biasing member disposed to bias said actuating shaft to the normal position.

2. The cutting angle adjustment device according to claim 1, wherein said forefront arcuate edge has a plurality of scaling notches angularly displaced from one another about the central axis, said device further comprising:
a fixing unit having an anchoring end secured to said arm, a leaf spring segment extending radially to terminate at an urging end that is disposed beneath said forefront arcuate edge, and that is biased upwardly so as to be kept in slidable contact with said forefront arcuate edge during angular movement of said arm, and a retaining member which is disposed on said urging end and which is to be snapped into engagement with a selected one of said scaling notches.

3. The cutting angle adjustment device according to claim 2, wherein said actuating shaft has an intermediate segment which is interposed between said actuating end and said externally operable end,
said adjustment actuating unit further having a hook-up mechanism which includes
a sleeve body mounted on and rotated with said intermediate segment,
a flange extending radially and outwardly from said sleeve body, and
a catch disposed on said retaining member such that, when said actuating shaft is moved to the pressed position, said flange is forced over said catch and is rotatably retained with said catch against the biasing force of said biasing member so as to guard against disengagement of said pinion from said arcuate rack segment, thereby keeping said actuating shaft in the pressed position.

4. The cutting angle adjustment device according to claim 3, wherein said fixing unit further includes a lever which has weight and power ends opposite to each other, and a fulcrum interposed between said weight and power ends and pivotally mounted on said arm, said weight end being disposed to abut against said leaf spring segment such that an upward force applied manually to said power end results in downward movement of said weight end and said leaf spring segment so as to disengage said retaining member from the selected one of said scaling notches and to release said flange from said catch, thereby permitting said actuating shaft to be biased to the normal position.

5. The cutting angle adjustment device according to claim 1, wherein said forefront arcuate edge has a plurality of scaling notches angularly displaced from one another about the central axis, said device further comprising:
a fixing unit including
an anchoring end secured to said table body and opposite to said arm radially,
a leaf spring segment which extends radially to terminate at an urging end that is disposed beneath said forefront arcuate edge, and that is biased upwardly so as to be kept in slidable contact with said forefront arcuate edge during angular movement of said arm,
a retaining member which is disposed on said urging end and which is to be snapped into engagement with a selected one of said scaling notches, and
a tongue segment extending forwardly from said urging end to facilitate manual operation of said tongue segment to disengage said retaining member from the selected one of said scaling notches.

6. The cutting angle adjustment device according to claim 1, said base frame has an arcuate abutment wall which is disposed uprightly on said frontward area and which extends angularly about the central axis, said device further comprising:
a tightening unit having a tightening bolt which is rotatably mounted on said arm and which has a threaded segment adjacent to said arcuate abutment wall, an abutment member which is threadedly engaged with said threaded segment such that rotation of said tightening bolt results in movement of said abutment member relative to said arcuate abutment wall, and a spring member which is interposed between said abutment member and said arcuate abutment wall such that said abutment member is moved to abut against said arcuate abutment wall against a biasing action of said spring member so as to guard against angular movement of said arm relative to said base frame.

7. The cutting angle adjustment device according to claim 6, wherein said tightening unit has a pad member which is disposed between said abutment member and said fine-adjustment unit adjacent to said arcuate abutment wall so as to stabilize threaded engagement between said tightening bolt and said abutment member.

8. The cutting angle adjustment device according to claim 6, wherein said actuating shaft is configured to be tubular so as to permit passage of said tightening bolt therethrough and to permit said tightening bolt to extend rearwardly of said actuating end to enable said threaded segment to be threadedly engaged with said abutment member.
